(19) United States
(12) Patent Application Publication
(10) Pub. No.: US 2024/0078734 A1
(43) Pub. Date: Mar. 7, 2024

(54) INFORMATION INTERACTION METHOD AND APPARATUS, ELECTRONIC DEVICE AND STORAGE MEDIUM

(71) Applicant: Beijing Zitiao Network Technology Co., Ltd., Beijing (CN)

(72) Inventors: Peipei WU, Beijing (CN); Wenhui ZHAO, Beijing (CN); Keda FANG, Beijing (CN); Tan HE, Beijing (CN); Liyue JI, Beijing (CN); Mengqi TU, Beijing (CN); Weicheng ZHANG, Beijing (CN)

(21) Appl. No.: 18/460,068

(22) Filed: Sep. 1, 2023

(30) Foreign Application Priority Data
Sep. 5, 2022 (CN) 202211080822.6

(51) Int. Cl. G06T 13/40; G06F 3/01; G06T 19/00

(52) U.S. Cl. CPC G06T 13/40; G06F 3/011; G06T 19/00

(57) ABSTRACT

An information interaction method and apparatus, an electronic device and a storage medium are provided, the method comprising: displaying a preset first special effect element in a virtual reality space; determining whether a spatial relationship between a target control part controlled by a user and displayed in the virtual reality space and the first special effect element meets a preset condition; and in response to determining that the preset condition is met, displaying a second special effect associated with the first special effect element.

### CROSS-REFERENCE TO RELATED APPLICATIONS

The present application is based on and claims priority to Chinese Patent Application No. 202211080822.6 filed on Sep. 5, 2022, and entitled “INFORMATION INTERACTION METHOD AND APPARATUS, ELECTRONIC DEVICE AND STORAGE MEDIUM”, the disclosure of which is incorporated by reference herein in its entirety.

### TECHNICAL FIELD

The present disclosure relates to the field of computer technologies, and in particular, to an information interaction method and apparatus, an electronic device, and a storage medium.

### BACKGROUND

With the development of Virtual Reality (VR), more and more virtual social platforms or applications are developed for use by users. In a virtual social platform, a user can control his/her avatar for social interaction with an avatar controlled by another user, entertainment, study, telecommuting, UGC (User Generated Content) creation, and the like through an intelligent terminal device such as head-mounted VR glasses. However, interaction forms provided by related virtual social platforms are too single to meet diversified interaction requirements of the user.

### SUMMARY

This SUMMARY is provided to introduce concepts in a simplified form, and the concepts will be described in detail in the following DETAILED DESCRIPTION. This SUMMARY is not intended to identify key features or essential features of the claimed technical solutions, nor is it intended to be used to limit the scope of the claimed technical solutions.

In a first aspect, according to one or more embodiments of the present disclosure, there is provided an information interaction method, comprising:
displaying a preset first special effect element in a virtual reality space;
determining whether a spatial relationship between a target control part controlled by a user and displayed in the virtual reality space and the first special effect element meets a preset condition;
in response to determining that the spatial relationship meets the preset condition, displaying a second special effect associated with the first special effect element.

In a second aspect, according to one or more embodiments of the present disclosure, there is provided an information interaction apparatus, comprising:
a first display unit configured to display a preset first special effect element in a virtual reality space;
a monitoring unit configured to determine whether a spatial relationship between a target control part controlled by a user and displayed in the virtual reality space and the first special effect element meets a preset condition;
a second display unit configured to, in response to determining that the spatial relationship meets the preset condition, display a second special effect associated with the first special effect element.

In a third aspect, according to one or more embodiments of the present disclosure, there is provided an electronic device, comprising: at least one memory and at least one processor; wherein the memory is configured to store program code, and the processor is configured to call the program code stored in the memory to cause the electronic device to perform the information interaction method provided according to one or more embodiments of the present disclosure.

In a fourth aspect, according to one or more embodiments of the present disclosure, there is provided a non-transitory computer storage medium storing program code, which, when executed by a computer device, causes the computer device to perform the information interaction method provided according to one or more embodiments of the present disclosure.

### BRIEF DESCRIPTION OF THE DRAWINGS

The above and other features, advantages, and aspects of the embodiments of the present disclosure will become more apparent by referring to the following DETAILED DESCRIPTION when taken in conjunction with the accompanying drawings. Throughout the drawings, the same or similar reference numbers refer to the same or similar elements. It should be understood that the drawings are schematic and that elements and components are not necessarily drawn to scale.

FIG. 1 is a flowchart of an information interaction method provided according to an embodiment of the present disclosure;

FIG. 2 is a schematic diagram of a virtual reality device according to an embodiment of the present disclosure;

FIG. 3 is an optional schematic view of a virtual field of view of a virtual reality device provided according to another embodiment of the present disclosure;

FIG. 4 is a schematic structural diagram of an electronic device provided according to an embodiment of the present disclosure.

### DETAILED DESCRIPTION

The embodiments of the present disclosure will be described in more detail below with reference to the accompanying drawings. While certain embodiments of the present disclosure are shown in the drawings, it should be understood that the present disclosure may be embodied in various forms and should not be construed as limited to the embodiments set forth herein, but rather these embodiments are provided for a more complete and thorough understanding of the present disclosure. It should be understood that the drawings and the embodiments of the present disclosure are for illustration purposes only and are not intended to limit the protection scope of the present disclosure.

It should be understood that the steps recited in the embodiments of the present disclosure may be performed in a different order, and/or performed in parallel. Moreover, the embodiments may include additional steps and/or omit performing the illustrated steps. The scope of the present disclosure is not limited in this respect.

The term “comprising” and variations thereof as used herein are intended to be open-ended, i.e., “comprising but not limited to”. The term “based on” is “based at least in part on”. The term “one embodiment” means “at least one embodiment”; the term “another embodiment” means “at least one additional embodiment”; the term “some embodiments” means “at least some embodiments”. The term “in response to” and related terms mean that one signal or event is affected by another signal or event to some extent, but not necessarily completely or directly. If an event x occurs “in response” to an event y, x may respond directly or indirectly to y. For example, the occurrence of y may ultimately result in the occurrence of x, but other intermediate events and/or conditions may exist. In other cases, y may not necessarily result in the occurrence of x, and x may occur even though y has not occurred yet. Furthermore, the term “in response to” may also mean “at least partially in response to”.

The term “determining” broadly encompasses a wide variety of actions that can include obtaining, calculating, computing, processing, deriving, investigating, looking up (e.g., looking up in a table, a database or another data structure), ascertaining and the like, and can also include receiving (e.g., receiving information), accessing (e.g., accessing data in a memory) and the like, as well as resolving, selecting, choosing, establishing and the like. Relevant definitions for other terms will be given in the following description.

It should be noted that the concepts “first”, “second”, and the like mentioned in the present disclosure are only used for distinguishing different devices, modules or units, and are not used for limiting the order or interdependence of the functions performed by the devices, modules or units.

It is noted that modifications of “a”, “an” or “a plurality of” mentioned in this disclosure are intended to be illustrative rather than limiting, and that those skilled in the art will appreciate that they should be understood as “one or more” unless otherwise explicitly stated in the context.

For the purpose of this disclosure, the phrase “A and/or B” means (A), (B), or (A and B).

The names of messages or information exchanged between devices in the embodiments of the present disclosure are for illustrative purposes only, and are not intended to limit the scope of the messages or information.

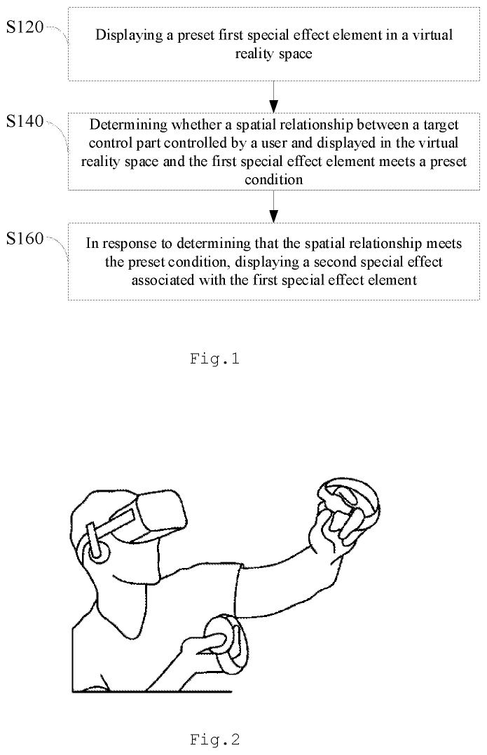

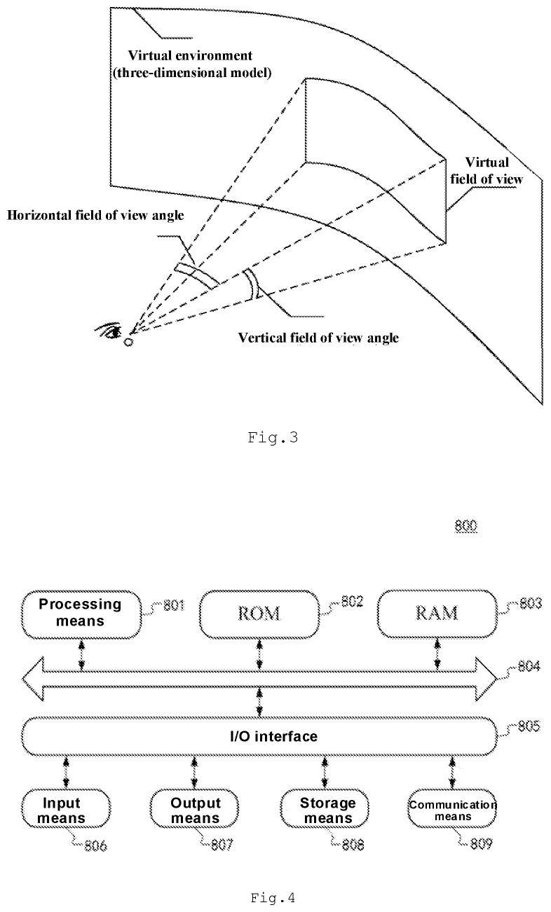

Referring to FIG. 1, FIG. 1 shows a flowchart of an information interaction method 100 provided according to an embodiment of the present disclosure, where the method 100 includes steps S120 to S160.

Step S120: displaying a preset first special effect element in a virtual reality space.

The virtual reality space may be a simulation environment of a real world, a semi-simulation semi-fictional virtual scene, or a pure fictional virtual scene. The virtual scene may be any one of a two-dimensional virtual scene, a 2.5-dimensional virtual scene, or a three-dimensional virtual scene, and the embodiments of the present application do not limit the dimensions of the virtual scene. For example, the virtual scene may include sky, land, ocean, etc., the land may include environmental elements such as desert, city, and the user may control a virtual object to move in the virtual scene.

Referring to FIG. 2, a user may enter a virtual reality space through a smart terminal device such as a head-mounted VR glasses, and control his/her own avatar for social interaction with avatars controlled by other users, entertainment, study, telecommuting, and the like in the virtual reality space.

In an embodiment, in the virtual reality space, the user can implement related interactive operations through a controller, and the controller can be a handle, for example, the user can perform related operation control through an operation on keys of the handle. Of course, in other embodiments, a target object in the virtual reality device may be controlled by using a gesture or voice or a multi-modal control mode instead of using the controller.

The information interaction method provided according to one or more embodiments of the present disclosure adopts an Extended Reality (XR) technology. The extended reality technology can combine reality and virtual through a computer, to provide a virtual reality space allowing human-computer interaction for a user. In the virtual reality space, the user may engage in social interaction, entertainment, study, work, telecommuting, User Generated Content (UGC) creation, and the like through a virtual reality device such as a Head Mounted Display (HMD).

The virtual reality device described in the embodiments of the present disclosure may include, but is not limited to, the following types:

A personal computer virtual reality (PCVR) device, that utilizes PC (personal computer)to perform related calculations of virtual reality functions and data output; an externally connected personal computer virtual reality device utilizes data output from the PC to realize a virtual reality effect.

A mobile virtual reality device, that supports the arrangement of a mobile terminal (such as a smartphone) in various manners (such as a head-mounted display provided with a special card slot); by connecting the mobile virtual reality device with the mobile terminal in a wired or wireless manner, the mobile terminal performs related calculations of virtual reality functions and outputs data to the mobile virtual reality device, for example, a virtual reality video is watched through an APP of the mobile terminal.

An all-in-one virtual reality device, that is provided with a processor for performing relevant calculations of virtual functions, and thus has independent virtual reality input and output functions, does not need to be connected with a PC or a mobile terminal, and has high use freedom.

Of course, the virtual reality device is not limited to such implementation forms, and may be further miniaturized or enlarged as needed.

The virtual reality device is provided with a sensor for gesture detection (such as a nine-axis sensor), for detecting a gesture change of the virtual reality device in real time; if a user wears the virtual reality device, when the gesture of the head of the user changes, the real-time gesture of the head is transmitted to the processor, thereby a gaze point of the sight of the user in the virtual environment is calculated; an image in a gazing range (namely the virtual field of view) of the user in the three-dimensional model of the virtual environment is calculated according to the gaze point, and the image is displayed on the display screen, so that the user can see the same immersive experience as if the user is in the real environment.

FIG. 2 illustrates an optional schematic diagram of a virtual field of view of a virtual reality device provided according to an embodiment of the present disclosure, where a horizontal field of view angle and a vertical field of view angle are used to describe a distribution range of the virtual field of view in the virtual environment, the distribution range in a vertical direction is represented by the vertical field of view angle BOC, the distribution range in a horizontal direction is represented by the horizontal field of view angle AOB, and a human eye can always perceive an image located in the virtual field of view in the virtual environment through a lens. As can be understood, the larger the field of view angle, the larger size of the virtual field of view, and the larger area of the virtual environment that can be perceived by the user. The field of view angle represents a distribution range of a view angle when the environment is perceived through the lens. For example, the field of view angle of the virtual reality device represents the distribution range of the view angle that the human eye has when perceiving the virtual environment through the lens of the virtual reality device; for another example, for a mobile terminal provided with a camera, the field of view angle of the camera is the distribution range of the view angle that the camera has when perceiving a real environment to shoot.

The virtual reality device, such as HMD, is integrated with several cameras (e.g., depth cameras, RGB cameras, etc.), and the purpose of the cameras is not limited to providing a through view only. Camera images and integrated inertial measurement units (IMUs) provide data that can be processed by computer vision methods to automatically analyze and understand the environment. Also, HMD is designed to support not only passive but also active computer vision analysis. Passive computer vision methods analyze image information captured from an environment. These methods may be monoscopic (images from a single camera) or stereoscopic (images from two cameras). They include, but are not limited to, feature tracking, object recognition, and depth estimation. Active computer vision methods add information to an environment by projecting a pattern that is visible to a camera, but not necessarily visible to a human visual system. Such techniques include time-of-flight (ToF) cameras, laser scanning, or structured light, to simplify the stereo matching problem. Active computer vision is used to achieve scene depth reconstruction.

In some embodiments, the virtual reality space comprises a virtual livestreaming space. In the virtual livestreaming space, a performer user can livestream in an avatar or real image, and an audience user can control an avatar to watch the performer's livestreaming in a watching view angle such as a first person view angle or a third person view angle. In some embodiments, a video stream may be acquired and video content may be presented in a video image display space based on the video stream. Illustratively, the video stream may be in an encoded format such as H.265, H.264, MPEG-4. In a specific implementation, a client may receive a livestreaming video stream sent by a server, and display livestreaming video images in the video image display space based on the livestreaming video stream.

In some embodiments, the first special effect element may comprise one or a set of virtual objects, and the first special effect element may be associated with a virtual reality scene; the first special effect element can be associated with a first special effect, the first special effect element being presented in the virtual reality space with the first special effect; presentation time of the first special effect element can last for a preset duration or until it is stopped or replaced by another special effect element.

In a specific implementation, a resource library storing special effect files may be provided in advance at a client, and the client may invoke a corresponding resource file from the resource library to render the first special effect element.

In some embodiments, the first special effect element may include, but is not limited to, an animation model, an animation special effect, a change to a display element or model in the virtual reality space. Illustratively, taking a livestreaming concert as an example for illustration, display elements in the virtual reality space may include, but are not limited to stage, scenery, lights, props, and other stage art designs. Illustratively, the first special effect element may include a paper airplane, a Kongming lantern, a dandelion, a hot air balloon, or other virtual objects.

In some embodiments, the preset first special effect element may be displayed in the virtual reality space according to a set first special effect. For example, a paper airplane special effect element may be moved in the virtual reality space according to a specific movement track, and the paper airplane special effect element may also be turned, deformed, changed in color, and the like during the movement, but the present disclosure is not limited thereto.

Step S140: determining whether a spatial relationship between a target control part controlled by a user and displayed in the virtual reality space and the first special effect element meets a preset condition.

In some embodiments, the target control part may be part or all of an avatar corresponding to the user, e.g., the target control part may be a hand of the avatar.

In some embodiments, the target control part may include a counterpart of a virtual reality control device (e.g., VR handle) in the virtual reality space. For example, an animation model corresponding to the virtual reality control device may be displayed in the virtual reality space.

In a specific implementation, a relative position relation between a VR handle and a VR headset may be obtained, and based on the relative position relation, a position of the VR handle in the virtual reality space is determined. Exemplarily, an infrared light source may be disposed on the housing of the VR handle, and the VR headset is provided with a binocular infrared camera for capturing the infrared light source; gesture information of the VR handle and gesture information of the VR headset are respectively measured; the relative position relation between the VR handle and the VR headset is calculated according to the gesture information of the VR handle and the VR headset and information of a picture captured by the binocular infrared camera; and the position of the animation model corresponding to the VR handle in the virtual reality space is determined, according to the position of the VR headset in the virtual reality space and the relative position relation between the VR handle and the VR headset.

Step S160: in response to determining that the spatial relationship meets the preset condition, displaying a second special effect associated with the first special effect element.

In some embodiments, the second special effect may include, but is not limited to, an animation model, an animation special effect, a change to a virtual object displayed in the virtual reality space. Illustratively, taking a livestreaming concert as an example for illustration, display elements in the virtual reality space may include, but are not limited to stage, scenery, lights, props, and other stage art designs. Illustratively, the second special effect may include a virtual object such as a paper airplane, a Kongming lantern, a dandelion, a hot air balloon, or an animation special effect such as a particle special effect, a flame special effect.

Illustratively, after it is determined that the spatial relationship meets the preset condition, the first special effect element may be converted into another virtual object, or another virtual object or an animation special effect may be added to the first special effect element, or a motion parameter (e.g., motion track, speed), a gesture, a shape, a size, and a display parameter (e.g., color, brightness, etc.) of the first special effect element may be changed.

In some embodiments, the second special effect may include one or a set of special effects; a presentation time of the second special effect may last for a preset duration or until it is stopped or replaced with another special effect.

In a specific implementation, a resource library storing special effect files may be provided in advance at the client, and the client may invoke a corresponding special effect file from the resource library to render the second special effect.

In some embodiments, the spatial relationship may include an orientation relationship and/or a distance relationship between the two.

In some embodiments, if the first special effect element is located at a specific orientation of the target control part (e.g. the first special effect element is located directly above the target control part) and/or a distance between the first special effect element and the target control part does not exceed a preset threshold, it is determined that the spatial relationship meets the present condition.

In some embodiments, the spatial relationship between the target control part and the first special effect element may be periodically monitored at a preset time interval, and if the distance between the target control part and the first special effect element does not exceed the preset threshold, it is determined that the spatial relationship meets the preset condition.

In a specific implementation, the target control part may be periodically monitored at a preset time interval, and when it is detected that the first special effect element appears within a preset spatial range centered on the target control part, it is determined that the spatial relationship meets the preset condition. The preset spatial range may be a spherical space, a cubic space, but the present disclosure is not limited thereto.

An exemplary description is given below. When the first special effect element is presented in the virtual reality space, the user can control the target control part to trigger one or more preset second special effects, for example, if the user controls the target control part to approach or touch a “hot air balloon” virtual object, a “hot air balloon flying upward” special effect is presented; if the user controls the target control part to approach or touch a “dandelion” animation image, a “dandelion gone with the wind” special effect is presented.

In addition, the second special effect and the first special effect element may also have no correlation in display logic, for example, the first special effect element is dandelion, and the second special effect is firework, which is not limited herein.

In this way, according to one or more embodiments of the present disclosure, when the spatial relationship between the target control part controlled by the user and displayed in the virtual reality space and the first special effect element meets the preset condition, the second special effect associated with the first special effect element is displayed, so that interactivity between the user and the special effect displayed in the virtual reality space can be improved, and interaction experience of the user in the virtual reality space can be further improved.

In some embodiments, the step S120 comprises:
step A1: moving the first special effect element in the virtual reality space along a preset path.

In some embodiments, different movement paths may be set for different special effects elements. Illustratively , if the first special effect element is a hot air balloon animation, the corresponding preset path may be an ascending path; if the first special effect element is a leaf animation, the corresponding preset path is a descending path.

In some embodiments, the step S120 comprises:
step B1: determining a position of an avatar corresponding to the user in the virtual reality space;
step B2: moving the first special effect element towards the position of the avatar.

In this embodiment, the first special effect element may move towards a direction in which the avatar of the user is located, to facilitate the user to control the avatar to approach or touch the first special effect element.

In some embodiments, the step S120 comprises:
step C1: randomly determining a movement end point of the first special effect element in the virtual reality space;
step C2: moving the first special effect element towards the movement end point.

Illustratively, the first special effect element may be randomly scattered in the virtual reality space.

In some embodiments, an special effect script file for displaying the second special effect may be set for the first special effect element in advance, so that when the first special effect element and the target control part meets the present spatial relationship, the second special effect may be rendered in the virtual reality space based on the special effect script file. The special effect script file is used for describing the second special effect, and when the first special effect element and the target control part meet the preset spatial relationship, the special effect script file associated with the first special effect element is correspondingly matched, thereby rendering the second special effect described in the special effect script file through a preset special effect rendering engine.

Correspondingly, according to an embodiment of the present disclosure, there is provided an information interaction apparatus, comprising:
a first display unit configured to display a preset first special effect element in a virtual reality space;
a monitoring unit configured to determine whether a spatial relationship between a target control part controlled by a user and displayed in the virtual reality space and the first special effect element meets a preset condition; and
a second display unit configured to, in response to determining that the spatial relationship meets the preset condition, display a second special effect associated with the first special effect element.

In some embodiments, the first display unit is configured to display the preset first special effect element in the virtual reality space according to a set first special effect.

In some embodiments, the first display unit is configured to move the first special effect element in the virtual reality space along a preset path.

In some embodiments, the first display unit is configured to determine a position of an avatar corresponding to the user in the virtual reality space, and to move the first special effect element toward the position of the avatar.

In some embodiments, the first display unit is configured to randomly determine a movement end point of the first special effect element in the virtual reality space, and to move the first special effect element towards the movement end point.

In some embodiments, different special effects elements are associated with different preset paths.

In some embodiments, the information interaction apparatus further comprises:
a script setting unit configured to set an special effect script file for displaying the second special effect for the first special effect element in advance; the displaying the second special effect associated with the first special effect element comprises: rendering the second special effect in the virtual reality space based on the special effect script file.

In some embodiments, the monitoring unit is configured to periodically monitor whether the spatial relationship meets the preset condition at a preset time interval.

In some embodiments, it is determined that the spatial relationship meets the preset condition if a distance between the target control part and the first special effect element does not exceed a preset threshold.

For the embodiments of the apparatus, reference is made to the partial description of the method embodiments for relevant parts, since they substantially correspond to the method embodiments. The above-described apparatus embodiments are merely illustrative, in that modules illustrated as separate modules may or may not be separate. Some or all of the modules may be selected according to actual needs to achieve the purpose of the solution of this embodiment. One of ordinary skill in the art can understand and implement without paying out creative efforts.

Accordingly, according to one or more embodiments of the present disclosure, there is provided an electronic device comprising:
at least one memory and at least one processor;
wherein the memory is configured to store program code, and the processor is configured to call the program code stored in the memory to enable the electronic device to execute the information interaction method provided according to one or more embodiments of the present disclosure.

Accordingly, according to one or more embodiments of the present disclosure, there is provided a non-transitory computer storage medium storing program code executable by a computer device to cause the computer device to perform the information interaction method provided according to one or more embodiments of the present disclosure.

Refer to FIG. 4 below, which shows a schematic structural diagram of an electronic device (e.g., a terminal device or server) 800 suitable for use in implementing the embodiments of the present disclosure. The terminal device in the embodiments of the present disclosure may include, but is not limited to, a mobile terminal such as a mobile phone, a notebook computer, a digital broadcast receiver, a PDA (personal digital assistant), a PAD (tablet computer), a PMP (portable multimedia player), an in-vehicle terminal (e.g., an in-vehicle navigation terminal) and the like, and a fixed terminal such as a digital TV, a desktop computer and the like. The electronic device shown in FIG. 4 is only an example, and should not bring any limitation to the functions and the scope of use of the embodiments of the present disclosure.

As shown in FIG. 4, the electronic device 800 may comprise a processing means (e.g., a central processing unit, a graphics processing unit, etc.) 801, which may perform various appropriate actions and processes according to a program stored in a read-only memory (ROM) 802 or a program loaded from a storage means 808 into a random access memory (RAM) 803. In the RAM 803, various programs and data necessary for the operations of the electronic device 800 are also stored. The processing means 801, ROM 802, and RAM 803 are connected with each other via a bus 804. An input/output (I/O) interface 805 is also connected to the bus 804.

Generally, the following means may be connected to the I/O interface 805: an input means 806 including, for example, a touch screen, touch pad, keyboard, mouse, camera, microphone, accelerometer, gyroscope, etc.; an output means 807 including, for example, a liquid crystal display (LCD), speaker, vibrator, etc.; the storage means 808 including, for example, a magnetic tape, hard disk, etc.; and a communication means 809. The communication means 809 may allow the electronic device 800 to communicate with another device wirelessly or by wire to exchange data. While FIG. 4 illustrates the electronic device 800 having the various means, it should be understood that not all illustrated means are required to be implemented or provided. More or fewer means may be alternatively implemented or provided.

In particular, according to an embodiment of the present disclosure, the processes described above with reference to the flow diagrams may be implemented as a computer software program. For example, an embodiment of the present disclosure comprises a computer program product, the computer program product comprising a computer program carried on a computer-readable medium, the computer program containing program code for performing the method illustrated by the flow diagrams. In such an embodiment, the computer program may be downloaded from a network via the communication means 809 and installed, or installed from the storage means 808, or installed from the ROM 802. When executed by the processing means 801, the computer program performs the above functions defined in the method of the embodiments of the present disclosure.

It should be noted that the above computer-readable medium of the present disclosure may be a computer-readable signal medium or a computer-readable storage medium or any combination of the above two. The computer-readable storage medium may be, for example, but not limited to, an electronic, magnetic, optical, electromagnetic, infrared, or semiconductor system, apparatus, or device, or any combination of the foregoing. More specific examples of the computer-readable storage medium may comprise, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium that contains, or stores a program for use by or in conjunction with an instruction execution system, apparatus, or device. In contrast, in the present disclosure, the computer-readable signal medium may comprise a data signal propagated in baseband or as part of a carrier wave, in which computer-readable program code is carried. Such a propagated data signal may take a variety of forms, including, but not limited to, an electromagnetic signal, optical signal, or any suitable combination of the forgoing. The computer-readable signal medium may also be any computer-readable medium other than the computer-readable storage medium, wherein the computer-readable signal medium can send, propagate, or transmit a program for use by or in conjunction with an instruction execution system, apparatus, or device. The program code contained on the computer-readable medium may be transmitted using any appropriate medium, including but not limited to: a wire, an optical cable, RF (Radio Frequency), etc., or any suitable combination of the foregoing.

In some embodiments, a client and a server may communicate using any currently known or future developed network protocol, such as HTTP (HyperText Transfer Protocol), and may be interconnected with any form or medium of digital data communication (e.g., a communication network). Examples of the communication network include a local area network (“LAN”), a wide area network (“WAN”), an internet (e.g., the Internet), and a peer-to-peer network (e.g., an ad hoc peer-to-peer network), as well as any currently known or future developed network.

The above computer-readable medium may be embodied in the above electronic device; or may be exist separately without being assembled into the electronic device.

The above computer-readable medium has one or more programs carried thereon, wherein the above one or more programs, when executed by the electronic device, cause the electronic device to perform the above method of the disclosure.

Computer program code for performing the operations of the present disclosure may be written in one or more programming languages, which include an object-oriented programming language such as Java, Smalltalk, C++, and also include a conventional procedural programming language, such as the “C” language or similar programming languages, or a combination thereof. The program code may be executed entirely on a user's computer, partly on the user's computer, as a stand-alone software package, partly on the user's computer and partly on a remote computer, or entirely on the remote computer or server. In a scenario where the remote computer is involved, the remote computer may be connected to the user's computer through any type of network, including a local area network (LAN) or a wide area network (WAN), or may be connected to an external computer (for example, through the Internet using an Internet service provider).

The flow diagrams and block diagrams in the drawings illustrate the possibly implemented architecture, functions, and operations of the system, method and computer program product according to various embodiments of the present disclosure. In this regard, each block in the flow diagrams or block diagrams may represent one module, program segment, or portion of code, which comprises one or more executable instructions for implementing a specified logical function. It should also be noted that, in some alternative implementations, functions noted in blocks may occur in an order different from that noted in the drawings. For example, two blocks shown in succession may, in fact, be executed substantially concurrently, or the blocks may sometimes be executed in a reverse order, which depends upon the functions involved. It will also be noted that each block of the block diagrams and/or flow diagrams, and a combination of the blocks in the block diagrams and/or flow diagrams, can be implemented by a special-purpose hardware-based system that performs specified functions or operations, or by a combination of special-purpose hardware and computer instructions.

The involved unit described in the embodiments of the present disclosure may be implemented by software or hardware. The name of the unit does not, in some cases, constitute a limitation on the unit itself.

The functions described above herein may be executed, at least partially, by one or more hardware logic components. For example, without limitation, exemplary types of the hardware logic component that may be used include: a field programmable gate array (FPGA), application specific integrated circuit (ASIC), application specific standard product (ASSP), system on chip (SOC), complex programmable logic device (CPLD), and the like.

In the context of this disclosure, a machine-readable medium may be a tangible medium, which can contain, or store a program for use by or in conjunction with an instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combination of the foregoing. More specific examples of the machine-readable storage medium should include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more embodiments of the present disclosure, there is provided an information interaction method, comprising: displaying a preset first special effect element in a virtual reality space; determining whether a spatial relationship between a target control part controlled by a user and displayed in the virtual reality space and the first special effect element meets a preset condition; in response to determining that the spatial relationship meets the preset condition, displaying a second special effect associated with the first special effect element.

According to one or more embodiments of the present disclosure, the displaying the preset first special effect element in the virtual reality space comprises: displaying the preset first special effect element in the virtual reality space according to a set first special effect.

According to one or more embodiments of the present disclosure, the displaying the preset first special effect element in the virtual reality space comprises: moving the first special effect element in the virtual reality space along a preset path.

According to one or more embodiments of the present disclosure, the displaying the preset first special effect element in the virtual reality space comprises: determining a position of an avatar corresponding to the user in the virtual reality space; and moving the first special effect element towards the position of the avatar.

According to one or more embodiments of the present disclosure, the displaying the preset first special effect element in the virtual reality space comprises: randomly determining a movement end point of the first special effect element in the virtual reality space; and moving the first special effect element towards the movement end point.

According to one or more embodiments of the present disclosure, different special effect elements are associated with different preset paths.

The information interaction method provided according to one or more embodiments of the present disclosure further comprises: setting an special effect script file for displaying the second special effect in advance for the first special effect element; the displaying the second special effect associated with the first special effect element comprises: rendering the second special effect in the virtual reality space based on the special effect script file.

According to one or more embodiments of the present disclosure, the determining whether the spatial relationship between the target control part controlled by the user and displayed in the virtual reality space and the first special effect element meets the preset condition comprises: periodically monitoring whether the spatial relationship meets the preset condition at a preset time interval.

According to one or more embodiments of the present disclosure, if a distance between the target control part and the first special effect element does not exceed a preset threshold, it is determined that the spatial relationship meets the preset condition.

According to one or more embodiments of the present disclosure, there is provided an information interaction apparatus comprising: a first display unit configured to display a preset first special effect element in a virtual reality space; a monitoring unit configured to determine whether a spatial relationship between a target control part controlled by a user and displayed in the virtual reality space and the first special effect element meets a preset condition; a second display unit configured to, in response to determining that the spatial relationship meets the preset condition, display a second special effect associated with the first special effect element.

According to one or more embodiments of the present disclosure, there is provided an electronic device, comprising: at least one memory and at least one processor; wherein the memory is configured to store program code, and the processor is configured to call the program code stored in the memory to cause the electronic device to perform the information interaction method provided according to one or more embodiments of the present disclosure.

According to one or more embodiments of the present disclosure, there is provided a non-transitory computer storage medium storing program code, which, when executed by a computer device, causes the computer device to perform the information interaction method provided according to one or more embodiments of the present disclosure.

The foregoing description is only the preferred embodiments of the present disclosure and an illustration of the technical principles employed. It should be appreciated by those skilled in the art that the disclosure scope involved in the present disclosure is not limited to the technical solutions formed by specific combinations of the technical features described above, but also encompasses other technical solutions formed by arbitrary combinations of the above technical features or equivalent features thereof without departing from the above disclosed concepts. For example, a technical solution formed by performing mutual replacement between the above features and technical features having similar functions disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing might be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims.

What is claimed is:

1. An information interaction method, comprising:
displaying a preset first special effect element in a virtual reality space;
determining whether a spatial relationship between a target control part controlled by a user and displayed in the virtual reality space and the first special effect element meets a preset condition; and
in response to determining that the spatial relationship meets the preset condition, displaying a second special effect associated with the first special effect element.

2. The method according to claim 1, wherein, the displaying the preset first special effect element in the virtual reality space, comprises:
displaying the preset first special effect element in the virtual reality space according to a set first special effect.

3. The method according to claim 1, wherein, the displaying the preset first special effect element in the virtual reality space, comprises:
moving the first special effect element in the virtual reality space along a preset path.

4. The method according to claim 1, wherein, the displaying the preset first special effect element in the virtual reality space, comprises:
determining a position of an avatar corresponding to the user in the virtual reality space; and
moving the first special effect element towards the position of the avatar.

5. The method according to claim 1, wherein, the displaying the preset first special effect element in the virtual reality space, comprises:
randomly determining a movement end point of the first special effect element in the virtual reality space; and
moving the first special effect element towards the movement end point.

6. The method according to claim 3, wherein, different special effect elements are associated with different preset paths.

7. The method according to claim 1, further comprising: setting an special effect script file for displaying the second special effect in advance for the first special effect element;
the displaying the second special effect associated with the first special effect element comprises: rendering the second special effect in the virtual reality space based on the special effect script file.

8. The method according to claim 1, wherein, the determining whether the spatial relationship between the target control part controlled by the user and displayed in the virtual reality space and the first special effect element meets the preset condition, comprises:
periodically monitoring whether the spatial relationship meets the preset condition at a preset time interval.

9. The method according to claim 1, wherein, if a distance between the target control part and the first special effect element does not exceed a preset threshold, it is determined that the spatial relationship meets the preset condition.

10. An electronic device, comprising:
at least one memory and at least one processor;
wherein the memory is configured to store program code, and the processor is configured to call the program code stored in the memory to cause the electronic device to perform the steps of:
displaying a preset first special effect element in a virtual reality space;
determining whether a spatial relationship between a target control part controlled by a user and displayed in the virtual reality space and the first special effect element meets a preset condition; and
in response to determining that the spatial relationship meets the preset condition, displaying a second special effect associated with the first special effect element.

11. The electronic device according to claim 10, wherein, the step of displaying the preset first special effect element in the virtual reality space, comprises:
displaying the preset first special effect element in the virtual reality space according to a set first special effect.

12. The electronic device according to claim 10, wherein, the step of displaying the preset first special effect element in the virtual reality space, comprises:
moving the first special effect element in the virtual reality space along a preset path.

13. The electronic device according to claim 10, wherein, the step of displaying the preset first special effect element in the virtual reality space, comprises:
determining a position of an avatar corresponding to the user in the virtual reality space; and
moving the first special effect element towards the position of the avatar.

14. The electronic device according to claim 10, wherein, the step of displaying the preset first special effect element in the virtual reality space, comprises:
randomly determining a movement end point of the first special effect element in the virtual reality space; and
moving the first special effect element towards the movement end point.

15. The electronic device according to claim 12, wherein, different special effect elements are associated with different preset paths.

16. The electronic device according to claim 10, further comprising the step of: setting an special effect script file for displaying the second special effect in advance for the first special effect element;
the step of displaying the second special effect associated with the first special effect element comprises: rendering the second special effect in the virtual reality space based on the special effect script file.

17. The electronic device according to claim 10, wherein, the step of determining whether the spatial relationship between the target control part controlled by the user and displayed in the virtual reality space and the first special effect element meets the preset condition, comprises:
periodically monitoring whether the spatial relationship meets the preset condition at a preset time interval.

18. The electronic device according to claim 10, wherein, if a distance between the target control part and the first special effect element does not exceed a preset threshold, it is determined that the spatial relationship meets the preset condition.

19. A non-transitory computer storage medium, storing program code, which, when executed by a computer device, causes the computer device to perform the steps of:
displaying a preset first special effect element in a virtual reality space;
determining whether a spatial relationship between a target control part controlled by a user and displayed in the virtual reality space and the first special effect element meets a preset condition; and
in response to determining that the spatial relationship meets the preset condition, displaying a second special effect associated with the first special effect element.
